(19) United States
(12) Patent Application Publication
(10) Pub. No.: US 2020/0142047 A1
(43) Pub. Date: May 7, 2020

(54) SPATIAL IMAGING USING WIRELESS NETWORKS

(71) Applicant: Gil ZWIRN, Petah Tikva (IL)

(72) Inventor: Gil ZWIRN, Petah Tikva (IL)

(21) Appl. No.: 16/630,484

(22) PCT Filed: Jun. 28, 2018
(86) PCT No.: PCT/IB2018/054810

§ 371 Date: Jan. 13, 2020

(30) Foreign Application Priority Data
Jul. 14, 2017 (IL) 253488

(51) Int. Cl. G01S 13/00; G01S 13/04; G01S 7/41; G01S 7/35

(52) U.S. Cl. CPC G01S 13/003; G01S 7/354; G01S 7/411; G01S 13/04

(57) ABSTRACT

Methods for acquiring information regarding terrain and/or objects within a target volume using wireless networks (“spatial imaging”), providing an estimate of local signal reflectivity within the target volume (“local estimated signal”), some of which comprise: receiving signals transmitted by one or more nodes of wireless networks using one or more receiving units (“node signal receivers” (30)), wherein the transmitted signals are “node signals” (20) and the signals received after traversing a medium (21) are “node resultant signals” (22), and wherein each of the one or more node signal receivers (30) is configured to receive signals associated with one or more transmitting nodes of wireless networks (“transmitting subject network nodes” (11)); and for at least one of the one or more node signal receivers (30), for at least one of the associated one or more transmitting subject network nodes (11), generating an initial version of the local estimated signal (“bi-static local estimated signal”), using the following processing steps: (a) apply matched filtering between the node resultant signal received by the current node signal receiver and the waveform of the current transmitting subject network node, wherein the output of the matched filtering (“matched node resultant signal”) is provided as a function of time, wherein time is correlated to a bi-static range with respect to the current node signal receiver and the current transmitting subject network node; (b) for one or more spatial locations within the target volume (60), compute the bi-static range with respect to the current node signal receiver and the current transmitting subject network node (“bi-static distance”), wherein the spatial location of each of the current node signal receiver and the current transmitting subject network node is known, measured, or estimated; and (c) for each of the one or more spatial locations within the target volume (60), determine the bi-static local estimated signal based on the value of the matched node resultant signal at the bi-static distance corresponding to the current spatial location.

### FIELD OF THE INVENTION

The present invention relates generally to employing wireless networks for acquiring information regarding terrain and/or objects within a volume of interest (“spatial imaging”).

### BACKGROUND OF THE INVENTION

### Wireless Networks and Their Uses

Wireless networks are used to transfer information between two or more spatial locations which are not physically linked. The information may be of any kind, e.g., voice, still or moving images, text, and so forth. The information is typically transferred using radio frequency (RF) and/or infrared radiation.

Some of the common types of wireless networks, divided according to coverage area and network topology, are:

(a) Wireless personal area networks (WPANs), such as Bluetooth networks, which interconnect devices within a relatively small area;
(b) Wireless local area networks (WLANs), linking two or more devices over a relatively short distance, usually providing internet connection through an access point;
(c) Wireless mesh networks, whose nodes are organized in mesh topology, in which each node forwards messages on behalf of other nodes. Such networks automatically reroute around faulty nodes;
(d) Wireless metropolitan area networks (wireless MANs), e.g., WiMax, which may connect several WLANs;
(e) Wireless wide area networks (wireless WANs), which typically cover large areas, e.g., between neighboring towns;
(f) Cellular networks or mobile networks, distributed over areas called cells, each of which served by at least one fixed-location transceiver, known as a cell site or base station. Each cell typically uses a set of radio frequencies and/or codes which is different from that of the immediate neighboring cells, so as to reduce interference. When joined together, multiple cells may provide coverage over wide geographic areas, enabling a large number of portable transceivers, such as smart phones and tabled computers, to communicate with each other and with fixed transceivers anywhere in the network, via base stations. Although originally intended for telephone conversations, cellular networks also routinely carry other types of data, using technologies such as: frequency division multiple access (FDMA), time division multiple access (TDMA), global system for mobile communications (GSM), code division multiple access (CDMA), general packet radio service (GPRS), wideband code division multiple access (W-CDMA), enhanced data rates for GSM evolution (EDGE), CDMA2000, orthogonal frequency division multiple access (OFDMA), and so forth; and
(g) Mobile satellite communications, based on telecommunication satellites. Typically used when other types of wireless connection are unavailable, e.g., in largely rural areas and remote locations, in aviation, or in maritime platforms.

The location of mobile devices (e.g., cellular phones) connected to wireless networks is sometimes estimated using these networks. The estimation may be based on measurements made directly by the wireless network infrastructure and/or on external sources of information, e.g., global navigation satellite system (GNSS) trackers associated with the mobile devices. For example, US patent application US2012/109853, by Culpepper, Smith, and Vancleave, published on May 3, 2012, titled “Method and system for providing tracking services to locate an asset,” discloses a method and system for asset location. Location data is received from a cellular transmitter associated with a selected asset, which location data includes data representative of a cellular receiver with which direct communication with the cellular transmitter is made. The location data is then communicated to a tracking service system, which tracking service system includes a database representative of geographic locations associated with the plurality of cellular receivers. The database is then queried with received location data so as to generate geographic tracking data associated with a location of a cellular receiver, the geographic tracking data including display data adapted to generate a map image including a representative of a location of the selected asset. The geographic tracking data is then communicated to an associated security agency so as to allow for viewing of an image generated in accordance with the display data and at least one of tracking and interception of the selected asset. In some embodiments, location data is also received from a GNSS location system associated with the cellular transmitter. An example is US patent application US2010/120449, by Jakorinne, Kuisma, and Paananen, published on May 13, 2010, titled “Method and system for refining accuracy of location positioning,” which discloses a method and system for accurately determining the location of a mobile device. In the mapping phase, collected reference positioning data and collected cell data are used to map a covered area estimation, and in the actual location determination phase, the covered area estimation is calculated from actual environment data received through a wireless cellular communication network, and possibly but not necessarily from external databases. The covered area estimation comprises at least some of the following calculations: (i) estimation of base station location; (ii) estimation of transmission range; (iii) estimation of signal map; and (iv) estimation of area type. The actual location of the mobile device is determined from the covered area estimation based on relative comparison between the actual environment data and estimations (i)-(iv) and weight numbers resulted from the comparison. During both phases, a database is stored in the server and updated whenever new environment data is received. A further example is US patent application US2011/0059752, by Gain, Do, and Zhang, published on Mar. 10, 2011, titled “Concurrent wireless transmitter mapping and mobile station positioning,” which discloses a method for concurrently estimating locations for one or more mobile stations and one or more mobile transmitters, said method comprising: receiving at a computing platform a plurality of range measurements from one or more mobile stations with unknown positions, the plurality of range measurements comprising one or more range measurements to one or more wireless transmitters with unknown positions and one or more range measurements to one or more wireless transmitters with known positions; and concurrently estimating locations for the one or more mobile stations with unknown positions and for the one or more wireless transmitters with unknown positions.

Wireless networks can also be used to estimate the location of multiple mobile devices as a function of time. Based on this information, one can create road maps, analyze traffic flow and provide dynamic route guidance for drivers. For example, US patent application US2010/211301, by McClellan, published on Aug. 19, 2010, titled “System and method for analyzing traffic flow,” discloses a system and method for analyzing traffic flow, comprising receiving location reports from a plurality of mobile devices, each of the location reports identifying a current location and current speed for a particular mobile device. For each of the location reports, the system identifies a current street from a street mapping database using the current location. The system stores the current speeds for the mobile devices so that each of the current speeds is associated with a street in the street mapping database. The current speeds may be stored in the street mapping database or in a separate database that is linked to the street mapping database. A further example is US patent application US2010/057336, by Levine, Shinar, and Shabtai, published on Mar. 4, 2011, titled “System and method for road map creation,” which discloses a system and method for creation of a road map, the system comprising a plurality of navigation devices; and an application server to receive from the plurality of navigation devices time series of location points, and to create a road map based on the time series of location points. The method comprises receiving location points from a plurality of navigation devices, along with respective time stamps indicating the time of recordation of each of the location points; identifying at least one route according to the location points and respective time stamps; and creating a road map based on the at least one route. An even further example is US patent application US2011/098915, by Disatnik, Shmuelevitz, and Levine, published on Apr. 28, 2011, titled “Device, system, and method of dynamic route guidance,” which discloses a device, system and method of dynamic route guidance. For example, the method may include: calculating an optimal route from a first location, in which a navigation device is located, to a destination point entered by a user of said navigation device; receiving from the navigation device a travel update, indicating that the navigation device is located in a second location, wherein the second location is on said optimal route; and based on real-time traffic information and real-time road information, determining that an alternate route, from the second location to the destination point, is now an optimal route to the destination point.

Furthermore, mobile devices connected to wireless networks can be used to map network performance parameters as a function of space and/or time. For example, US patent application US2006/246887, by Barclay, Benco, Mahajan, McRoberts, and Ruggerio, published on Nov. 2, 2006, titled “Mapping of weak RF signal areas in a wireless telecommunication system using customers' mobile units,” discloses a wireless mobile device, which includes an RF transmitter and receiver, where the receiver monitors signal strength of an RF signal from a base station. A control logic module compares the signal strength to a comparison level. The control logic module creates and stores a record in a memory module. The record includes a first signal strength level and parameters related to conditions existing at the time the comparing was done. The control logic module creates and stores the record if the level of said signal strength is less than the comparison level.

When fixed or mobile devices connected to a wireless network are associated with sensors capable of measuring one or more local physical parameters, the system can be used for detecting events in space and/or in time, e.g., for security purposes. For instance, US patent application US2008/169921, by Peeters, published on Jul. 17, 2008, titled “Method and apparatus for wide area surveillance of a terrorist or personal threat,” discloses methods and apparatuses for the wide area detection of major threats, including chemical, radiological or biological threats, using modified personal wireless devices, such as mobile phones, personal digital assistants (PDAs) or watches, combined with micro- and nano-sensor technologies. A “homeland security” chip is further provided, which combines the elements of geo-location, remote wireless communication and sensing into a single chip. The personal electronic devices can be further equipped for detecting various medically related threats. Similarly modified personal devices can be used to detect external threats that are person-specific. Another example is U.S. Pat. No. 7,952,476, by Causey, Andrus, Luu, Jones, and Henry, issued on May 31, 2011, titled “Mobile security system,” which discloses a mobile security system, wherein a detector communicates with a mobile device if an event has occurred. The event may be of various types, such as fire or motion. Once the mobile device receives the communication of the event occurrence, the mobile device may, among others, sound an alarm or communicate with a central monitoring system to notify emergency services of the occurrence. The mobile device may also communicate with another communication device, such as another cell phone or a computer, using various forms of communication. The detector may be an integral part of the mobile device, and may also be wholly separate.

### Object Detection Using RF Sensors

Certain methods and systems known in the art employ sensors based on RF radiation for object detection outside the context of wireless networks.

In some systems, the object detection is based on active sensing. For instance, UK patent application GB2473743, by Bowring and Andrews, published on Mar. 23, 2011, titled “Detecting hidden objects,” discloses a system and method for detecting and identifying hidden objects, for instance for airport security screening. Low power plane-polarized microwave radiation is directed towards a person, and scattered radiation is detected by a detector sensitive to polarization in an orthogonal plane (cross-polarization). The transmitted and received planes of polarization are varied, either by rotation of both transmitting and receiving antennas on a common platform, synchronized rotation of both, or switching between antennas having fixed polarizations. The transmitted frequency is modulated over a broad range, using wide-band frequency modulation continuous wave (FMCW). The output signal of the receiver over a period of time is compared with expected returns in a neural network to identify the nature of any hidden object, and can distinguish a large knife, small knife, handgun, and so on. An ultrasound sonar or stereoscopic camera may determine the distance to the person. Another example is PCT application WO2009/090406, by Mehta, published on Jul. 23, 2009, titled “Microwave imaging system,” which discloses a microwave imaging system for imaging a defined region, the system comprising a plurality of portable RF identification (RFID) tags, distributed around said region, for generating a plurality of RF signals and directing said signals to said defined region, and for receiving RF signals from said defined region; and means for transmitting the characteristics of said received signals to a remote processing station through a wireless communication channel, extracting image data from said received signals and constructing a corresponding image.

Other systems are based on passive sensing. For example, U.S. Pat. No. 8,179,310, by Westphal, issued on May 15, 2012, titled “Method for sensing a threat,” discloses a method for threat analysis based on the passive radar principle, using the transmitter in navigation satellites, a plurality of receiving stations, which are operated distributed over wide regions, and at least one evaluation center. The receiving stations act as wake-up sensors, transmit their received signals to at least one evaluation center for comparison with expected signals from each navigation satellite, and sense a threat. Depending on the result, stationary or mobile radar systems can then be used to obtain more precise details relating to a conspicuous entity, making it possible to decide on currently required protective or defensive measures. A further example is US patent application US2011/057828, by Brunet, published on Mar. 10, 2011, titled “Mapping method implementing a passive radar,” which discloses a mapping method implementing a radar used in passive mode. It is possible to use such a radar for locating an object likely to reflect an electromagnetic wave transmitted by a transmitter the position of which is known. Movable objects capable of reflecting rays received from transmitters of opportunity are used. The method comprises the following operations: determining, in a distance-Doppler matrix of the radar, points relative to the deviations between the rays received directly from the transmitters and the rays reflected by the movable object; transferring to a map to be established a probable zone of location of singularities of the electromagnetic field transmitted or reflected by the ground; and crossing several probable zones during the movement of the movable object in order to obtain the location of the singularities.

### Object Detection Using Wireless Network Infrastructure

Moreover, some methods and systems known in the art perform object detection using wireless network infrastructure. US patent application US2009/0040952, by Cover and Andersen, published on Feb. 12, 2009, titled “Systems and methods for microwave tomography,” discloses systems and methods for microwave tomography. According to various embodiments, signal strength values or other similar quality indications may be analyzed as they are received with packet data over a wireless network. The analysis may be used to determine the presence of a physical object substantially between communicating nodes in a wireless network. An output may be generated based on analyzed data. In addition, U.S. Pat. No. 6,745,038, by Callaway, Perkins, Shi, and Patwari, issued on Jun. 1, 2004, title “Intra-piconet location determination and tomography,” discloses a technique for intra-piconet location determination and tomography. This technique uses received signal strength indicator (RSSI) values in conjunction with transmitted power levels to determine the relative location of each device within a small network employing frequency hopped spread spectrum transmission. In addition to capability of location determination, the geometry of the devices in the network, as well as the path loss information between pairs of devices, may be used to infer the location of absorbers and reflectors within the piconet. This absorption and reflection information may be used in creating the piconet tomography. The approach described in this specification may be applied in conjunction with the Bluetooth PAN specification to determine device locations, mitigate the effects of multi-path, and perform indoor location and security functions, and other application functions requiring cost-effective location determination.

### SUMMARY OF THE INVENTION

Embodiments of the present invention provide methods and systems for acquiring information regarding terrain and/or objects within a target volume using wireless networks (“spatial imaging”).

According to a first aspect of the invention, there is provided a method for spatial imaging, providing an estimate of local signal reflectivity within a target volume (“local estimated signal”), said method comprising:

receiving signals transmitted by one or more nodes of wireless networks using one or more receiving units (“node signal receivers” (30)), wherein the transmitted signals are “node signals” (20) and the signals received after traversing a medium (21) are “node resultant signals” (22), and wherein each of said one or more node signal receivers (30) is configured to receive signals associated with one or more transmitting nodes of wireless networks (“transmitting subject network nodes” (11)); and
for at least one of said one or more node signal receivers (30), for at least one of said associated one or more transmitting subject network nodes (11), generating an initial version of said local estimated signal (“bi-static local estimated signal”), using the following processing steps:
(a) Apply matched filtering between said node resultant signal received by the current node signal receiver and the waveform of the current transmitting subject network node, wherein the output of the matched filtering (“matched node resultant signal”) is provided as a function of time, wherein time is correlated to a bi-static range with respect to said current node signal receiver and said current transmitting subject network node;
(b) For one or more spatial locations within the target volume (60), compute said bi-static range with respect to said current node signal receiver and said current transmitting subject network node (“bi-static distance”), wherein the spatial location of each of said current node signal receiver and said current transmitting subject network node is known, measured, or estimated; and
(c) For each of said one or more spatial locations within the target volume (60), determine said bi-static local estimated signal based on the value of said matched node resultant signal at said bi-static distance corresponding to the current spatial location.

Other aspects of the present invention are detailed in the claims.

### BRIEF DESCRIPTION OF THE DRAWINGS

The invention for employing wireless networks for acquiring information regarding terrain and/or objects within a volume of interest (“spatial imaging”) is herein described, by way of example only, with reference to the accompanying drawings.

With specific reference now to the drawings in detail, it is emphasized that the particulars shown are by way of example and for purposes of illustrative discussion of the embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 is a schematic, pictorial illustration of a system for spatial imaging, in accordance with an embodiment of the present invention. Wireless transmissions are marked by dash-dotted lines, and data lines, which may be wired or wireless, are marked by dotted lines;

FIG. 2 is a schematic, pictorial illustration of a system for spatial imaging, in accordance with an embodiment of the present invention. Wireless transmissions are marked by dash-dotted lines, and data lines, which may be wired or wireless, are marked by dotted lines;

FIG. 3 is a schematic block diagram of a node signal receiver (30), in accordance with an embodiment of the present invention. The blocks with dashed outlines, (35) and (36), are optional. Solid lines, dotted lines, and dash-dotted lines, represent data lines, control lines (optional), and power lines respectively;

FIG. 4 is a schematic block diagram of spatial imaging processing, in accordance with an embodiment of the present invention. The block with dashed outlines, 400, is optional;

FIG. 5 is a schematic block diagram of optional post-processing for spatial imaging, which may be applied to the local estimated signal (or to the bi-static local estimated signal), in accordance with an embodiment of the present invention. The blocks have dashed outlines, since they are all optional;

FIG. 6 is a schematic, pictorial illustration of spatial imaging geometry in two dimensions, in accordance with an embodiment of the present invention. The location of the transmitting subject network node (11) is marked by a black star, the location of the node signal receiver (30) is marked by a black circle, and a spatial location within the target volume (60) is marked by a gray diamond. All spatial locations along the dashed ellipse have the same bi-static distance as the gray diamond with respect to the transmitting subject network node (11) and the node signal receiver (30);

FIG. 7A is a schematic, pictorial illustration of a simulation scenario including two transmitting subject network nodes (11), three node signal receivers (30), and two point (or point-like) reflectors within the target volume, in accordance with an embodiment of the present invention. The transmitting subject network nodes are marked by circles (601 and 602), the node signal receivers are marked by X′s (610, 611, and 612), and the point reflectors are marked by points (621 and 622);

FIG. 7B is a pictorial illustration of the local estimated signal for the scenario of FIG. 7A, without using the variability factor, in accordance with an embodiment of the present invention. The local gray level indicates the value of the local estimated signal (regions with higher values are brighter). The local estimated signal was produced using a simulation, wherein each of the transmitting subject network nodes (11) employed a bandwidth of 50 MHz, and wherein each of the node signal receivers (30) used multiple concurrent receive beams (each with an azimuth beam width of 22°);

FIG. 7C is a pictorial illustration of the local variability factor (based on the overall energy ratio) for the scenario of FIG. 7A, in accordance with an embodiment of the present invention. The local gray level indicates the value of the local variability factor (regions with higher values are brighter). The local variability factor was produced using a simulation, wherein each of the transmitting subject network nodes (11) employed a bandwidth of 50 MHz, and wherein each of the node signal receivers (30) used multiple concurrent receive beams (each with an azimuth beam width of 22°);

FIG. 7D is a pictorial illustration of the local estimated signal for the scenario of FIG. 7A, using the variability factor (based on the overall energy ratio), in accordance with an embodiment of the present invention. The local gray level indicates the value of the local estimated signal (regions with higher values are brighter). The local estimated signal was produced using a simulation, wherein each of the transmitting subject network nodes (11) employed a bandwidth of 50 MHz, and wherein each of the node signal receivers (30) used multiple concurrent receive beams (each with an azimuth beam width of 22°); and

FIG. 8 is a pictorial illustration of the bi-static local estimated signals for the scenario of FIG. 7A, in accordance with an embodiment of the present invention. The local gray level indicates the value of the bi-static local estimated signals (regions with higher values are brighter). Panel A refers to transmitting subject network node 601 and node signal receiver 610; Panel B refers to transmitting subject network node 601 and node signal receiver 611; Panel C refers to transmitting subject network node 601 and node signal receiver 612; Panel D refers to transmitting subject network node 602 and node signal receiver 610; Panel E refers to transmitting subject network node 602 and node signal receiver 611; and Panel F refers to transmitting subject network node 602 and node signal receiver 612. The bi-static local estimated signals were produced using a simulation, wherein each of the transmitting subject network nodes (11) employed a bandwidth of 50 MHz, and wherein each of the node signal receivers (30) used multiple concurrent receive beams (each with an azimuth beam width of 22°).

### DETAILED DESCRIPTION OF EMBODIMENTS

### System Description

In broad terms, the present invention relates to methods and systems for acquiring information regarding terrain and/or objects within a volume of interest using wireless networks (“spatial imaging”). The volume of interest will be referred to as a “target volume”.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In embodiments of the present invention, one or more wireless networks (“subject networks”) include multiple nodes, wherein one or more of the nodes of the subject networks (“transmitting subject network nodes” (11)) transmit signals over time (“node signals” (20)). The node signals (20) are received by one or more receiving units (“node signal receivers” (30)), after traversing a medium (21), such as the atmosphere or free space, and undergoing various physical phenomena such as attenuation, reflection, scattering, refraction, diffraction, dispersion, multi-path, and so forth, wherein the various physical phenomena result from interactions with the medium and possibly terrain and/or objects within the target volume (the resulting signals are referred to as “node resultant signals” (22)). The outputs of the node signal receivers (30) are further processed by one or more processing units (“mapping units” (45)). The spatial imaging processing, described herein below, may be performed by the node signal receivers (30) and/or by the mapping units (45).

In some embodiments, the system further includes one or more user interface units, capable of controlling the system and/or displaying its outputs. The user interface units may employ any computing platform, such as a server, a desktop, a laptop, a tablet computer, a smart phone, and the like.

Each of the subject networks may be of any type known in the art, e.g., WPAN, WLAN, wireless mesh network, wireless MAN, wireless WAN, cellular network, mobile satellite communications network, radio network, and/or television network. The transmitting subject network nodes (11) may be of any kind known in the art, e.g., base stations and/or mobile phones in a cellular network.

Each of the transmitting subject network nodes (11) may employ any waveform known in the art. For instance, to allow separating signals associated with different subject network nodes and reduce mutual interference, different transmitting subject network nodes (11) may use different frequency bands, different code types (e.g., linear frequency modulation, phase shift keying, frequency shift keying, quadrature amplitude modulation, and so forth), different sets of code parameters, and/or different polarization schemes (e.g., horizontal or vertical linear polarization, right-hand or left-hand circular polarization, and so on). Multiple access methods may also be employed, e.g., time division multiple access (TDMA), frequency division multiple access (FDMA), code division multiple access (CDMA), or orthogonal frequency division multiple access (OFDMA). In some embodiments, the transmitting subject network nodes (11) may employ the same waveform, but be sufficiently separated spatially (e.g., the transmitting subject network nodes (11) may be distant from each other and/or transmit at separated spatial angles) to support reasonable differentiation and acceptable levels of mutual interference.

Each of the transmitting subject network nodes (11) may be either stationary or mobile.

In certain embodiments, all node signals (20) are produced as part of the normal operation of wireless networks. In other embodiments, some or all of the node signals (20) are especially produced for spatial imaging purposes; for example, one or more nodes may transmit signals at time dependent directions, scanning the target volume over time.

In embodiments, each node signal receiver (30) may be either stationary or mobile.

In certain embodiments, each node signal receiver (30) may be either passive (i.e., only capable of receiving) or active (i.e., capable of both transmitting and receiving signals. Note that the term “node signal receiver” should not be regarded as limiting to signal reception only).

In further embodiments, at least one of the node signal receivers (30) is associated (e.g., integrated) with a node of a wireless network. For example, with cellular subject networks, at least one of the node signal receivers (30) may be integrated with a cellular base station.

In some embodiments, node signal receivers (30) include at least the following:

(a) An antenna module (31), used for receiving signals. In active node signal receivers, the antenna module (31) is also used for transmitting signals;
(b) An RF module (32), applying at least analog-to-digital (A/D) conversion to the signal received from the antenna module (31). In active node signal receivers, the RF module (32) also includes a transmitter, feeding the antenna module (31);
(c) A digital module (33), processing samples generated by the RF module (32). The digital module (33) may further determine parameters for the RF module (32) and/or the antenna module (31). The digital module (33) may include one or more of the following: a central processing unit (CPU), a graphic processing unit (GPU), a digital signal processor (DSP), a field-programmable gate array (FPGA), or an application specific integrated circuit (ASIC); and
(d) A power supply (34), which may include a battery.

The RF module (32) and/or the digital module (33) may also address one or more of the following: gain control, down-conversion, matched filtering, and beamforming. The digital module (33) may further perform some of the processing associated with spatial imaging of the target volume, as described herein below.

In certain embodiments, node signal receivers (30) may also include one or more of the following:

(a) A global navigation satellite system (GNSS) receiver (35), e.g., a GPS receiver, providing accurate time and location information to the digital module (33);
(b) A wired or wireless communication module (36), which can be used for data transfer between the digital module (33) and the mapping units (45), for example via an intranet or the internet.

In some embodiments, each node signal receiver (30) may employ one or more of the following:

(a) A single receive beam, pointing at a constant direction. In such cases, the antenna module (31) may employ, for instance, a horn or a planar array antenna;
(b) A single receive beam, whose direction may change over time, by mechanical and/or electronic steering. In such cases, the antenna module (31) may employ, for example, a phased array; and
(c) Multiple concurrent receive beams, each pointing at a different spatial angle, and configured as a staring array.

In embodiments, each mapping unit (45) may either be a central mapping unit (50) or a local mapping unit (40). In certain embodiments, the outputs of all node signal receivers (30) are processed by one or more central mapping units (50). In other embodiments, local mapping units (40) are assigned to groups of one or more node signal receivers (30). In further embodiments, local mapping units (40) are assigned to groups of one or more node signal receivers (30), and one or more central mapping units (50) aggregate and further process the outputs of the local mapping units (40).

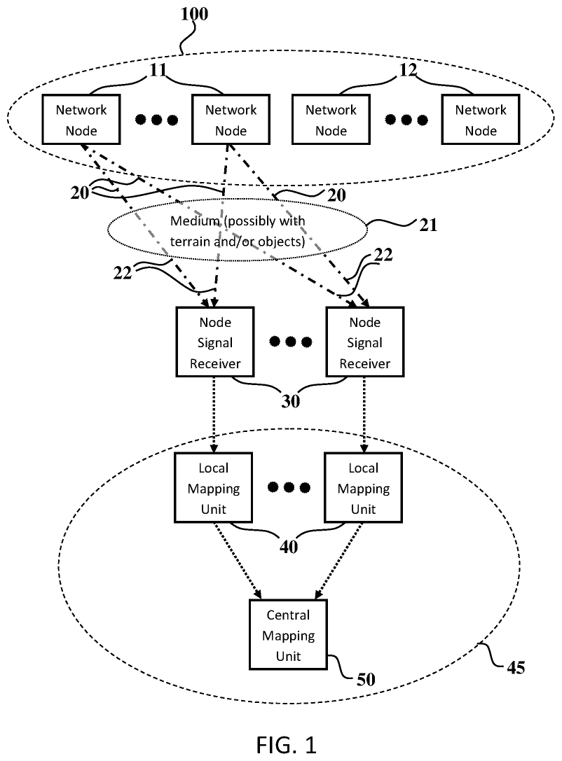

An example for a system configuration, wherein none of the node signal receivers is directly associated with a node of the subject network (each node signal receiver directly associated with a node of the subject networks may, for instance, be integrated with that node), can be seen in FIG. 1. The subject network (100) comprises transmitting subject network nodes (11) and non-transmitting subject network nodes (12). The node signals (20) traverse the medium (21), and the node resultant signals (22) are received by the node signal receivers (30). These signals are then processed by the local mapping units (40) and/or central mapping unit (50).

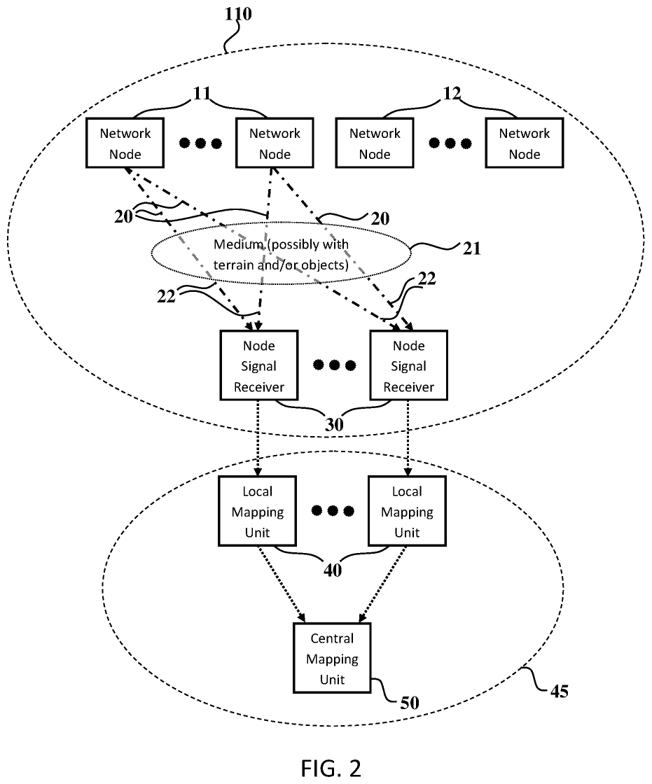

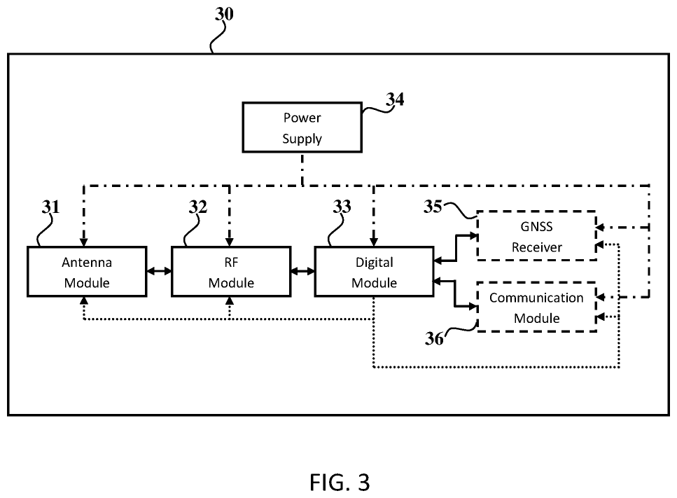

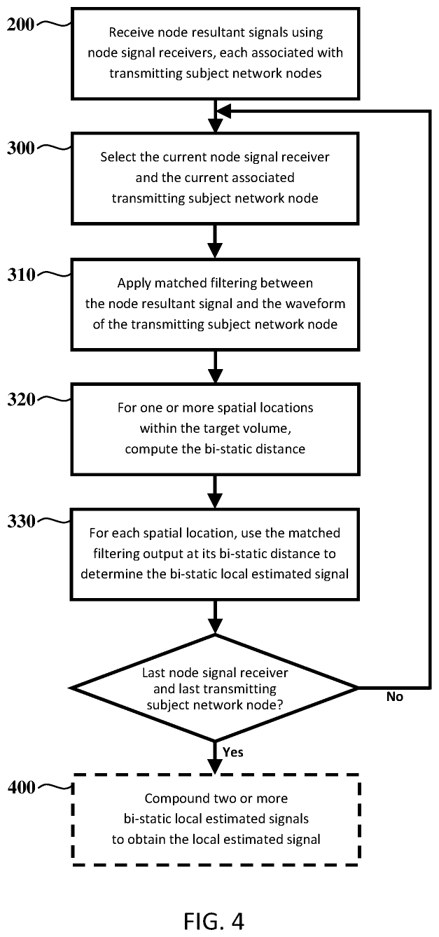

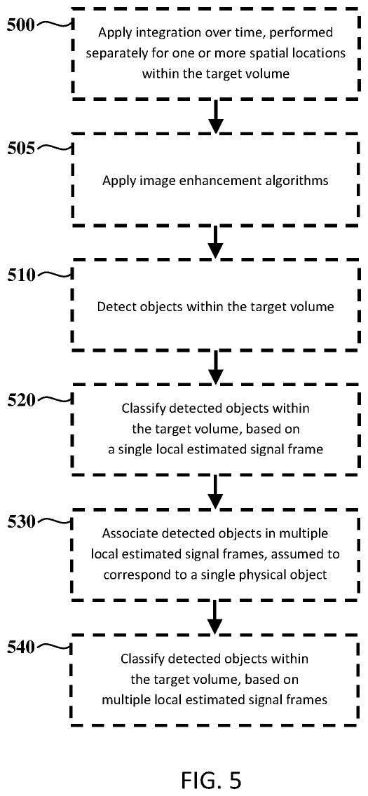

Another example for a system configuration, wherein all node signal receivers are associated with nodes of the subject network, can be seen in FIG. 2. The subject network (110) comprises transmitting subject network nodes (11), non-transmitting subject network nodes (12), and node signal receivers (30). The node signals (20) traverse the medium (21), and the node resultant signals (22) are received by the node signal receivers (30). These signals are then processed by the local mapping units (40) and/or central mapping unit (50).

### Spatial Imaging

In embodiments of the present invention, spatial imaging provides an estimate of the local signal reflectivity within the target volume (“local estimated signal”), resulting from terrain and/or objects within the target volume. Note that an object's reflectivity may depend on the transmission frequency as well as on the spatial angles of the transmitting antenna (in our case, the antenna associated with the transmitting subject network node (11)) and the receiving antenna (in our case, the antenna module (31) of the node signal receiver (30)) with respect to the object. The local estimated signal thus provides “typical” values of objects' reflectivity, which may be based on compounding multiple bi-static measurements. In certain cases, at least some of the bi-static measurements may use different frequency bands.

Conceptually, one can think of spatial imaging as using the antenna modules (31) of multiple node signal receivers (30) as a sparse receiving antenna, which is focused at a set of spatial locations (using various processing steps, e.g., processing similar to applying true-time-delay corrections) to produce the local estimated signal. This may be done separately for multiple transmitting subject network nodes (11), and the results for the different transmitting subject network nodes may be compounded to provide the final local estimated signal. This concept is expected to be more accurate when there is direct line-of-sight between each transmitting subject network node (11) and the corresponding node signal receivers (30) (i.e., when the channel is Rician). This can be achieved with relative ease for long term evolution (LTE) based subject networks, for instance, where base stations are densely deployed, striving to provide line-of-sight between the base stations and the user equipment (UE) they serve.

In some embodiments, spatial imaging comprises:

(a) Step 200: Receiving node resultant signals (22) using one or more node signal receivers (30), wherein each of the one or more node signal receivers is configured to receive signals associated with one or more transmitting subject network nodes (11);
(b) Step 300: For at least one of the one or more node signal receivers (30), for at least one of the associated one or more transmitting subject network nodes (11), generating an initial version of the local estimated signal (referred to as the “bi-static local estimated signal”, since a single transmitting subject network node (11) and a single node signal receiver (30) are used), using the following processing steps:

(i) Step 310: Apply matched filtering between the node resultant signal received by the current node signal receiver and the waveform of the current transmitting subject network node, wherein the output of the matched filtering (“matched node resultant signal”) is provided as a function of time, wherein time is correlated to a bi-static range with respect to the current node signal receiver and the current transmitting subject network node;

(ii) Step 320: For one or more spatial locations within the target volume (60), compute the bi-static range with respect to the current node signal receiver and the current transmitting subject network node (“bi-static distance”), wherein the spatial location of each of the current node signal receiver and the current transmitting subject network node is known (based on a-priori information, direct measurement, and/or or estimation); and

(iii) Step 330: For each of the one or more spatial locations within the target volume (60), determine the bi-static local estimated signal based on the value of the matched node resultant signal at the bi-static distance corresponding to the current spatial location.

In embodiments, spatial imaging further comprises:

(a) Step 400: Compounding two or more bi-static local estimated signals, associated with two or more node signal receivers (30) and/or two or more transmitting subject network nodes (11), to obtain the local estimated signal.

The compounding of two or more bi-static local estimated signals, performed in step 400, may result in one or more of the following benefits:

(a) Enhanced signal to noise ratios (SNRs), due to integration over multiple information sources;
(b) Reduced multi-path artifacts, since multi-path is expected to behave differently along different signal paths, and in this case using different transmitting subject network nodes (11) and/or different node signal receivers (30); and
(c) Each bi-static local estimated signals can be characterized by its point-spread function (PSF), which may change as a function of spatial location and/or time (the PSF as a function of spatial location and/or time is referred to as the “PSF model”). Different bi-static local estimated signals may have dissimilar PSF models, due to visibility differences. Compounding two or more bi-static local estimated signals is thus expected to improve the overall PSF model.

In certain embodiments, spatial imaging may be applied once, using node resultant signals (22) associated with a certain time swath. In other embodiments, spatial imaging may be applied multiple times (in multiple instances), wherein each instance is associated with a different time swath (in such cases, the output of each instance is referred to as a “local estimated signal frame”).

In some embodiments, spatial imaging may further comprise one or more of the following post-processing steps, applied to the local estimated signal (or to the bi-static local estimated signal):

(a) Step 500: Applying integration over time, wherein the integration is performed separately for one or more spatial locations within the target volume. A possible objective for such integration over time is SNR enhancement;
(b) Step 505: Applying image enhancement algorithms, for instance, de-noising algorithms. Any image enhancement algorithm known in the art may be employed; and
(c) Step 510: Detecting objects within the target volume.

In further embodiments, spatial imaging may also comprise one or more of the following post-processing steps, applied to the local estimated signal (or to the bi-static local estimated signal):

(a) Step 520: Classifying detected objects within the target volume, based on a single local estimated signal frame;
(b) Step 530: Associating detected objects in multiple local estimated signal frames, wherein the associated detected objects are assumed to correspond to a single physical object. The association outputs may be employed for generating a record of the physical object's location and attributes over time (“track file”); and
(c) Step 540: Classifying detected objects within the target volume, based on multiple local estimated signal frames, using the track files of step 530.

In some embodiments, the local estimated signal is provided for a set of spatial locations within the target volume (60), organized as a predefined grid. The predefined grid may be one-dimensional, two-dimensional, or three-dimensional. The predefined grid may follow any arrangement. For instance, the predefined grid may be rectangular of hexagonal. In some cases, the elevation of the predefined grid may be defined so as to follow the terrain, based on digital terrain maps (DTM).

### Matched Filtering Application (Step 310)

In embodiments of step 310, each of the waveforms of the transmitting subject network nodes (11) may be one or more of the following:

(a) Fully known in advance, and used in its entirety for the matched filtering;
(b) Partially known in advance, wherein only the part known in advance is used for the matched filtering;
(c) Partially known in advance, wherein the unknown part or certain portions thereof are estimated based on the communication protocol used by the transmitting subject network node (11), and wherein both the part known in advance and the estimated part are used for the matched filtering; and
(d) Not known in advance, and partially or fully estimated based on the communication protocol used by the transmitting subject network node (11), wherein the estimated part is used for the matched filtering.
For instance, LTE base-stations transmit some predefined signals, separated in time and carrier frequency, referred to as the “reference signal” (RS). The RS is used by the user equipment (UE) to estimate the channel's transfer function as a function of time and carrier frequency (this process is often referred to as “channel estimation”). In this example, only the RS is known in advance, but the remainder of the base-station signal may be estimated using standard LTE protocol decoding (demodulation) methods.

OFDMA is based on a series of orthogonal narrow-band transmissions. Each narrow-band transmission, typically referred to as a “resource element” (RE), is associated with a certain time slot and a certain carrier frequency.

In some embodiments of step 310, wherein one or more of the transmitting subject network nodes (11) employ OFDMA, the matched filtering associated with these transmitting subject network nodes (11) is applied using a single RE. In such cases, the range resolution of the matched node resultant signal is approximately cτ, wherein c is the speed of light and τ is the duration of the RE time slot (this also applies to bi-static radars using narrow-band transmissions). For example, the typical τ for LTE base-stations is 66.7 μsec, resulting in a range resolution of about 20 km for the matched node resultant signal.

In further embodiments of step 310, wherein one or more of the transmitting subject network nodes (11) employ OFDMA, the matched filtering associated with these transmitting subject network nodes (11) is applied using multiple concurrent REs. A possible method for applying matched filtering in such cases (“concurrent RE filtering”):

(a) Use the node signal receiver (30) to take a single sample for each RE (“per-RE sample”), wherein the sample may be real or complex. The sample may be in radio-frequency (RF), intermediate frequency (IF), or base-band; and
(b) Apply discrete inverse Fourier Transform to the per-RE samples, wherein each input of the discrete inverse Fourier Transform is associated with a specific carrier frequency and each output is associated with a specific time tag.
The concurrent RE filtering method is accurate when all reflectors within the target volume can be approximated as point reflectors. For example, if the target volume includes P point reflectors at bi-static distances dₚ, according to the wave equation, the complex per-RE sample at carrier frequency f_{c} can be described by:

$$s ( {f}_{c} ) = {\sum }_{p} {a}_{p} exp ( i 2 π \frac{{f}_{c}}{c} {d}_{p} ) \qquad ( 1 )$$

Wherein s(f_{c}) is the per-RE sample at carrier frequency f_{c}, aₚ is the amplitude associated with point reflector p (depends on its reflectivity as well as on path-loss), and i is the square root of (−1). As can be seen in Eq. (1), applying discrete inverse Fourier Transform to s(f_{c}), wherein each input is associated with a specific carrier frequency, results in range resolution enhancement.
In such cases, the range resolution of the matched node resultant signal is approximately c/B, wherein B is the total bandwidth employed for matched filtering. For example, if B equals 50 MHz (a typical total bandwidth for LTE Advanced base-stations, when channel aggregation is employed. The term “channel aggregation” is defined herein below. Other B values may also be used, e.g., up to 20 MHz for LTE base-stations, and possibly up to 1 GHz or more in future 5G base-stations), the range resolution of the matched node resultant signal is about 6 m.

In even further embodiments of step 310, wherein one or more of the transmitting subject network nodes (11) employ OFDMA, the matched filtering associated with these transmitting subject network nodes (11) is applied to multiple REs which are not all concurrent, wherein each RE is associated with a different carrier frequency. Some possible matched filtering methods in such cases:

(a) Apply the concurrent RE filtering method described herein above, disregarding the time tag associated with each RE; and
(b) Apply the concurrent RE filtering method for each time slot separately, using the corresponding group of REs. In some embodiments, one may increase the effective number of per-RE samples by applying interpolation to the per-RE samples over time and/or over the carrier frequency. Note that a similar method is employed for channel estimation in LTE networks. In certain embodiments, results for two or more time slots may then be compounded, for instance by coherent integration, performed separately for each spatial location within the target volume (60).

In certain embodiments of step 310, the waveform of one or more transmitting subject network nodes (11) does not employ a single continuous frequency band, but rather two or more continuous frequency bands. This configuration, often referred to as “channel aggregation”, is sometimes used due to spectrum allocation limitations. One of the following may be employed for the matched filtering applied for each transmitting subject network node using channel aggregation:

(a) Treat the transmitting subject network node as two or more transmitting subject network nodes, each associated with a different continuous frequency band of the waveform. Note that this increases the number of bi-static local estimated signals;
(b) Apply interpolation over the transmission frequency axis between the different continuous frequency bands of the waveform, so as to produce a single (and typically wide) continuous frequency band, and then apply matched filtering. This processing is expected to enhance the range resolution of the matched node resultant signal, and can be seen as a super-resolution method; and
(c) Apply the matched filtering without special regard to the use of channel aggregation.

In some embodiments of step 310, two or more transmitting subject network nodes (11) may be co-located or essentially co-located (“co-located nodes”), and use orthogonal frequency bands. In such cases, one of the following may be employed for the matched filtering associated with co-located nodes:

(a) Treat each of the co-located nodes as a separate transmitting subject network node;
(b) Apply matched filtering together to the node resultant signals associated with the co-located nodes; and
(c) Apply interpolation over the transmission frequency axis between the node resultant signals associated with the co-located nodes, so as to produce a single continuous frequency band, and then apply matched filtering. This processing is expected to enhance the range resolution of the matched node resultant signal, and can be seen as a super-resolution method.

### Bi-Static Distance Computation (Step 320)

For a given spatial location \vec{x}_{q}, its bi-static distance D_{q} with respect to a transmitting subject network node (11) and a node signal receiver (30) is defined as:

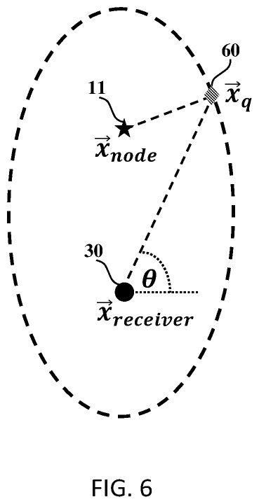

D_{q}=|\vec{x}_{q}−\vec{x}_{node}|+|\vec{x}_{q}−\vec{x}_{receiver}| (2)

Wherein \vec{x}_{node} is the spatial location of the transmitting subject network node (11), \vec{x}_{receiver} is the spatial location of the node signal receiver (30), and |.| is the vector magnitude operator.
Note that all geometric locations over an ellipsoid whose centers match the spatial locations of the transmitting subject network node (11) and the node signal receiver (30) have the same bi-static distance.
FIG. 6 illustrates this geometry in two-dimensions.

In some embodiments of step 320, the spatial locations of the current node signal receiver and/or the current transmitting subject network node are measured by means of a navigation system, e.g., using GNSS and/or inertial navigation, wherein the resulting location information may or may not be filtered over time to enhance results.

In further embodiments of step 320, the spatial locations of the current node signal receiver and/or the current transmitting subject network node are estimated using any method known in the art, e.g., the methods of patent applications US2012/109853, US2010/120449 and/or US2011/0059752, referenced herein above.

### Bi-Static Estimated Signal Computation (Step 330)

In step 310, the matched node resultant signal as a function of time may be computed for a set of time indices, corresponding to a set of bi-static distances (referred to as “range-gates”). The range-gates may or may not be equidistant. The range-gates correspond to a discrete set of bi-static distances, so in some cases, at least one of the bi-static distances associated with the one or more spatial locations within the target volume (60) may not have a corresponding range-gate with the same bi-static distance. In such cases, the value of the matched node resultant signal at the bi-static distance corresponding to the current spatial location (“current bi-static distance”) may be estimated in step 330 by one of the following:

(a) Using the matched node resultant signal at a range-gate whose bi-static distance is closest to the current bi-static distance; and
(b) Applying interpolation to the matched node resultant signal so as to obtain its value at the current bi-static distance. Any interpolation method known in the art may be employed. For instance, one my use the following interpolation method, which typically provides good phase estimation:

(i) Apply discrete Fourier transform to the matched node resultant signal as a function of time, to obtain the “matched node resultant signal spectrum”. If the range-gates are not equidistant, non-uniform discrete Fourier transform should be used; and

(ii) Apply inverse Fourier transform to the matched node resultant signal spectrum, so as to determine the value at a time index tₙ, corresponding to the current bi-static distance. That is, if the matched node resultant signal spectrum is given for a set of temporal frequencies {fₘ}, the interpolation result s_{matched} (tₙ) is:

$${s}_{matched} ( {t}_{n} ) = \frac{1}{M} {\sum }_{m} {S}_{matched} ( {f}_{m} ) exp ( - i 2 π {f}_{m} {t}_{n} ) \qquad ( 3 )$$

Wherein M is the size of {fₘ}, and s_{matched}(fₘ) is the matched node resultant signal spectrum at temporal frequency fₘ.

In some embodiments of step 330, for each of the one or more spatial locations within the target volume (60), the bi-static local estimated signal is set to value of the matched node resultant signal at the bi-static distance corresponding to the current spatial location.

In other embodiments of step 330, for each of the one or more spatial locations within the target volume (60), the bi-static local estimated signal is set to a function of the matched node resultant signal at the bi-static distance corresponding to the current spatial location (“bi-static function”).

In further embodiments of step 330, the bi-static function also depends on one or more of the following parameters:

(a) The current bi-static distance;
(b) The distance between the current spatial location and the current transmitting subject network node;
(c) The distance between the current spatial location and the current node signal receiver;
(d) The spatial angle of the current spatial location with respect to the current transmitting subject network node;
(e) The spatial angle of the current spatial location with respect to the current node signal receiver;
(f) Various system parameters of the current transmitting subject network node, such as its carrier frequency, bandwidth, mean transmission power, maximal gain (on transmission), beam pattern (on transmission), and so forth; and
(g) Various system parameters of the current node signal receiver, such as its sensitivity, maximal gain (on reception), beam pattern (on reception), and so forth.

For example, in some embodiments of step 330, the bi-static function may include one or more of the following:

(a) A phase correction, subtracting a phase corresponding to the current bi-static distance. A possible use for such phase correction is allowing coherent integration of bi-static local estimated signals associated with different node signal receivers (30) and/or different transmitting subject network nodes (11). For instance, the bi-static function for a current bi-distance dₙ, F_{B}(dₙ) may be:

$${F}_{B} ( {d}_{n} ) = {s}_{matched} ( \frac{{d}_{n}}{c} ) exp ( - i 2 π \frac{{f}_{c}}{c} {d}_{n} ) \qquad ( 4 )$$

(b) A phase correction, subtracting a phase corresponding to the distance between the current spatial location and the current node signal receiver. A possible use for such phase correction is allowing coherent integration of bi-static local estimated signals associated with different node signal receivers (30);
(c) An energy compensation, countering the effect of path-loss between the current transmitting subject network node and the current spatial location. Such an energy compensation makes the bi-static local estimated signal less dependent on geometry, and a better representation of the local signal reflectivity;
(d) An energy compensation, countering the effect of path-loss between the current spatial location and the current node signal receiver. Such an energy compensation makes the bi-static local estimated signal less dependent on geometry, and a better representation of the local signal reflectivity;
(e) An energy compensation, countering the effect of the mean transmission power and/or maximal gain (on transmission) of the current transmitting subject network node. Such an energy compensation makes the bi-static local estimated signal less dependent on system parameters, and a better representation of the local signal reflectivity;
(f) An energy compensation, countering the effect of the sensitivity and/or maximal gain (on reception) of the current node signal receiver. Such an energy compensation makes the bi-static local estimated signal less dependent on system parameters, and a better representation of the local signal reflectivity;
(g) A multiplicative factor, limiting the effect of each node resultant signal on the bi-static local estimated signal to the region covered by the corresponding receive beam of the corresponding node signal receiver. For instance, the factor may equal 1 if the current spatial location is within the mainlobe of the receive beam of the current node signal receiver, and 0 otherwise;
(h) An energy correction, based on the beam pattern of the receive beam of the current node signal receiver at a spatial angle corresponding to the current spatial location. Such an energy correction is based on the assumption that the closer the origin of a reflected signal to the center of the receive beam mainlobe, the more likely it is to have a significant effect on the matched node resultant signal, so the corresponding bi-static local estimated signal should reflect that; and
(i) A multiplicative factor, reducing the effect of matched node resultant signals associated with relatively low bi-static distances. For example, the factor may equal 1 for bi-static distances higher than a predefined threshold, and 0 otherwise. The use of such a factor is based on the fact that the PSF model of bi-static local estimated signals is typically wider for lower bi-static distances.

In certain embodiments of step 330, at least one of the node signal receivers (30) employs multiple concurrent receive beams, each associated with a different node resultant signal. In such cases, the bi-static local estimated signal may be computed separately for one or more of the multiple concurrent receive beams. In further embodiments of step 330, bi-static local estimated signals associated with two or more of the multiple concurrent receive beams of the same node signal receiver (30) may be compounded. This may be done by one or more of the following:

(a) For each of the one or more spatial locations within the target volume (60), applying coherent integration (i.e., summation of the complex signals) between the bi-static local estimated signals associated with the two or more of the multiple concurrent receive beams. The coherent integration may assign the same weight to all of the multiple concurrent receive beams, or different weights to different ones of the multiple concurrent receive beams;
(b) For each of the one or more spatial locations within the target volume (60), applying non-coherent integration (i.e., summation of the absolute values) between the bi-static local estimated signals associated with the two or more of the multiple concurrent receive beams. The non-coherent integration may assign the same weight to all of the multiple concurrent receive beams, or different weights to different ones of the multiple concurrent receive beams; and
(c) For each of the one or more spatial locations within the target volume (60), averaging over the absolute values of the bi-static local estimated signals associated with the two or more of the multiple concurrent receive beams. Any type of averaging known in the art may be employed, e.g., arithmetic mean, geometric mean, harmonic mean, median, and so forth.

### Compounding of Bi-Static Local Estimated Signals (Step 400)

In some embodiments of step 400, the compounding two or more bi-static local estimated signals comprises one or more of the following:

(a) For one or more spatial locations within the target volume (60), applying coherent integration (i.e., summation of the complex signals) between the bi-static local estimated signals associated with the two or more node signal receivers (30) and/or the two or more transmitting subject network nodes (11). The coherent integration may assign the same weight to all bi-static local estimated signals, or different weights to different bi-static local estimated signals;
(b) For one or more spatial locations within the target volume (60), applying non-coherent integration (i.e., summation of the absolute values) between the bi-static local estimated signals associated with the two or more node signal receivers (30) and/or the two or more transmitting subject network nodes (11). The non-coherent integration may assign the same weight to all bi-static local estimated signals, or different weights to different bi-static local estimated signals;
(c) For one or more spatial locations within the target volume (60), averaging over the absolute values of the bi-static local estimated signals associated with the two or more node signal receivers (30) and/or the two or more transmitting subject network nodes (11). Any type of averaging known in the art may be employed, e.g., arithmetic mean, geometric mean, harmonic mean, median, and so forth.

Note that coherent integration is typically used only for signals in the same frequency band. Consequently, a possible compounding scheme would be:

(a) For each of the two or more transmitting subject network nodes (11), applying coherent integration over the bi-static local estimated signals associated with that transmitting subject network node and two or more node signal receivers (30); and
(b) Applying non-coherent integration between the results of step (a). A possible alternative compounding scheme would be applying non-coherent integration over all bi-static local estimated signals, associated with the two or more node signal receivers (30) and/or the two or more transmitting subject network nodes (11).

In further embodiments of step 400, the compounding two or more bi-static local estimated signals may employ a weight computed for each bi-static local estimated signal, wherein said weight is a function of the information quality level of the corresponding bi-static local estimated signal. The information quality level can be derived from one or more of the following:

(a) A certain statistic (e.g., mean, median, or a predefined percentile) of the estimated SNR for the corresponding matched node resultant signal. Higher SNRs are indicative of better information quality; and
(b) A certain statistic (e.g., mean over time and/or transmission frequency) of the auto-correlation width of the corresponding matched node resultant signal. Lower auto-correlation widths are indicative of better information quality.

In even further embodiments of step 400, the one or more spatial locations within the target volume (60) used for computing the two or more bi-static local estimated signals may not fully match (i.e., at least one of the spatial locations used by one of the bi-static local estimated signals is not used for at least one of the other bi-static local estimated signals). In such cases, the value of a bi-static local estimated signal at a certain spatial location may be estimated using spatial interpolation and/or extrapolation. Additionally or alternatively, one may apply temporal interpolation between multiple local estimated signal frames.

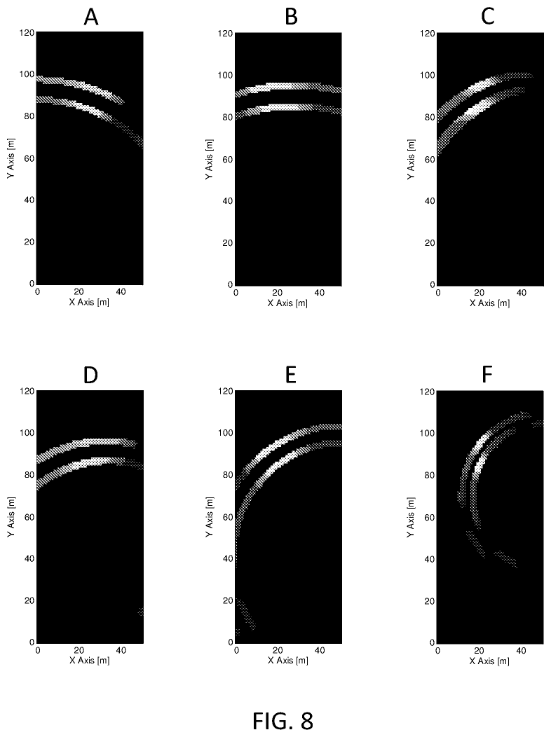

The PSF model for a bi-static local estimated signal may be relatively wide (as seen in the examples of FIG. 8, and discussed in the section “Spatial Imaging Example” herein below). When compounding two or more bi-static local estimated signals, the higher the number of bi-static local estimated signals used, the better the PSF model of the local estimated signal is expected to be. The PSF model of the local estimated signal may be further improved based on the following assumptions:

(a) Artifacts associated with imperfect PSF models are expected to have different effects in different bi-static local estimated signals;
(b) Conversely, spatial locations within the target volume (60) associated with relatively strong reflectors are expected to show relatively high (and similar) values in most or all bi-static local estimated signals.
In some embodiments of step 400, the compounding two or more bi-static local estimated signals involves computing a variability factor for one or more spatial locations within the target volume (60), wherein the variability factor is a local measure of the similarity between the values of the bi-static local estimated signals. For example, for one or more spatial locations within the target volume (60), the local estimated signal may be set to the result of coherent and/or non-coherent integration over the bi-static local estimated signals, multiplied by the variability factor.

In embodiments of step 400, the variability factor may relate to one or more of the following components of the values of the bi-static local estimated signals:

### (a) Magnitude;

### (b) Phase;

(c) Real component; and
(d) Imaginary component.

In further embodiments of step 400, the variability factor for a spatial location within the target volume (60) (the “present spatial location”) may be a function of the overall energy ratio, wherein the overall energy ratio for the present spatial location is computed as follows:

(a) Determine the absolute value of the two or more bi-static local estimated signals (being compounded) for the present spatial location (“overall bi-static array”); and
(b) Set the overall energy ratio to the ratio between the DC energy and the total energy of the overall bi-static array, which equals:

$$v ( {\vec{x}}_{q} ) = \frac{\frac{1}{K} {\vert {\sum }_{k} {b}_{k}^{q} \vert}^{2}}{{\sum }_{k} {\vert {b}_{k}^{q} \vert}^{2}} \qquad ( 5 )$$

Wherein v(\vec{x}_{q}) is the variability factor value for spatial location \vec{x}_{q}, bₖ^{q} is the overall bi-static array for spatial location \vec{x}_{q}, and K is the length of the overall bi-static array for spatial location \vec{x}_{q}. Note that the overall energy ratio ranges from 0 to 1, and is expected to be close to 1 in spatial locations within the target volume (60) associated with relatively strong reflectors.

Alternatively, the variability factor for the present spatial location may be a function of the average energy ratio, wherein the average energy ratio for the present spatial location is computed as follows:

(a) For each of the transmitting subject network nodes (11):

(i) Out of the two or more bi-static local estimated signals (being compounded), select the bi-static local estimated signals associated with the current transmitting subject network node;

(ii) Determine the value of these bi-static local estimated signals for the present spatial location (“partial bi-static array”);

(iii) Compute the ratio between the DC energy and the total energy of the partial bi-static array (“partial energy ratio”), which equals:

$$\tilde{v} ( {\vec{x}}_{q} ) = \frac{\frac{1}{K} {\vert {\sum }_{k} \vert}^{2}}{{\sum }_{k} {\vert \vert}^{2}} \qquad ( 6 )$$

Wherein \tilde{v}(\vec{x}_{q}) is the partial energy ratio for spatial location \vec{x}_{q}, [symbol] is the partial bi-static array for spatial location \vec{x}_{q}, and \tilde{K} is the length of the partial bi-static array for spatial location \vec{x}_{q}; and
(b) The average energy ratio is set to the average over all partial energy ratios.

In even further embodiments of step 400, the compounding two or more bi-static local estimated signals may further comprise iterative post-processing, for enhancing the PSF model of the local estimated signal. One or more of the following post-processing methods may be employed:

(a) A post-processing method based on the assumption that the highest magnitudes within the local estimated signal are associated with relatively strong reflectors rather than with artifacts due to imperfect PSF models. This assumption is reasonable since the compounding two or more bi-static local estimated signals typically reduces artifacts associated with imperfect PSF models. This post-processing method comprises:

(i) Detecting the spatial location or spatial locations within the target volume (60) associated with the highest magnitude region within the local estimated signal (“signal peak region”);

(ii) Treating the local estimated signal within the signal peak region as a description of one or more point reflectors within the target volume (“simulated peak reflectors”), whose spatial locations match the signal peak region and whose reflectivity levels equal the corresponding values of the local estimated signal; and estimating the node resultant signals that would have been obtained by the one or more node signal receivers (30) given the simulated peak reflectors, using the bi-static radar equation, to obtain the “simulated peak node resultant signals”;

(iii) Applying spatial imaging (without post-processing) to the simulated peak node resultant signals, to obtain the resulting local estimated signal (“simulated peak local estimated signal”). The simulated peak local estimated signal includes the signal peak region of the local estimated signal, as well as artifacts associated its PSF model;

(iv) For each of the spatial locations within the signal peak region, multiplying the local estimated signal by a factor of 2;

(v) For each of the spatial locations within the target volume (60) for which the local estimated signal is computed (“local estimated signal locations”), subtracting from the local estimated signal the simulated peak local estimated signal; and

(vi) As long as certain stopping criteria have not been met, detecting the next signal peak region, associated with the next highest magnitude region within the local estimated signal, and returning to step (ii).

The stopping criteria may include, for example, a maximal number of iterations to be performed, and/or a minimal ratio between the energy of the local estimated signal at the signal peak region and a certain statistic (e.g., mean, or a predefined percentile) of the energy of the local estimated signal; and

(b) A post-processing method trying to minimize the difference between the measured node resultant signals and the node resultant signals that would have been obtained given a set of point reflectors described by the local estimated signal (“simulated node resultant signals”), wherein the spatial locations of the set of point reflectors match the local estimated signal locations, and wherein the reflectivity levels of the set of point reflectors equal the corresponding values of the local estimated signal. This post-processing method comprises:

(i) Computing the simulated node resultant signals based on the local estimated signal. For each node signal receiver (30), for each transmitting subject network node (11), this can be done by:
(1) Treating the local estimated signal as a description of a set of point reflectors within the target volume, whose spatial locations match the local estimated signal locations, and whose reflectivity levels equal the corresponding values of the local estimated signal; and evaluating the resulting signal received by the current node signal receiver (“reflector signal”). The magnitude of the reflector signal is derived from the bi-static radar equation, and the phase of the reflector signal takes into account bi-static wave propagation; and
(2) For each receive beam, for each range-gate, determining the set of local estimated signal locations falling within a range swath associated with the current range-gate, and applying coherent integration over the corresponding reflector signals, to obtain the simulated node resultant signal;

(ii) For each node resultant signal, computing the difference between the corresponding simulated node resultant signal and the corresponding measured node resultant signal, to obtain the “node resultant signal difference”;

(iii) Applying spatial imaging (without post-processing) to the node resultant signal difference, to obtain the resulting local estimated signal (“simulated difference local estimated signal”);

(iv) For each of the local estimated signal locations, subtracting from the local estimated signal the value of the simulated difference local estimated signal; and

(v) As long as certain stopping criteria have not been met, return to step (i). The stopping criteria may include, for example, a maximal number of iterations to be performed, or a minimal mean magnitude of the simulated difference local estimated signal.

Integration over Time (Step 500)

In some embodiments of step 500, the integration over time may employ different integration times for different object types. The integration times may be derived from typical object dynamics. For instance, the motion velocity of pedestrians is expected to be lower than that of motor vehicles, so that integration times for pedestrians may be longer. The reflectivity of pedestrians is typically lower than the reflectivity of motor vehicles, so longer integration times may be necessary to achieve sufficient SNRs.

In further embodiments, when different integration times are employed for different object types, spatial processing is performed iteratively:

(a) Set the current integration time to the shortest integration time possible;
(b) Integrate the local estimated signal frames over time, using the current integration time. The integration may employ sliding-window processing;
(c) Apply further processing to the output of step (b), to detect objects of the types corresponding to the current integration time;
(d) Subtract from the local estimated signal frames the contribution of the detected objects; and
(e) If the current integration time is not the longest integration time possible, set the current integration time to the next shortest integration time and return to step (b).

### Object Detection (Step 510)

In some embodiments of step 510, the detecting objects within the target volume may be based on one or more of the following:

(a) Applying a local and/or a global threshold to the magnitude of the local estimated signal;
(b) Automatic recognition of various object types, such as cars, motorcycles, bicycles, pedestrians and so forth, using any automatic target recognition (ATR) method known in the art; and
(c) Motion detection, by arranging the local estimated signal frames in accordance with their acquisition time and applying any change detection algorithm known in the art.
Object Classification based on a Single Local Estimated Signal Frame (Step 520)

In certain embodiments of step 520, the classifying detected objects may employ any classification method known in the art. For instance, one or more of the following methods may be used for each object:

(a) One or more object characteristics may be computed. The object characteristics may include, for example, parameters relating to object dimensions, parameters relating to the object's motion velocity in the current local estimated signal frame, and/or parameters relating to the object's reflectivity. The computed object characteristics may then be compared to reference models associated with certain object types using any technique known in the art, for instance:

(i) Applying one or more thresholds to each object characteristic, to obtain a set of binary values. Predefined logic criteria may then be applied to the set of binary values, e.g., the sum of the binary values should exceed a certain number;

(ii) Applying one or more thresholds to each object characteristic, to obtain a set of binary values, and then using the Dempster-Shafer theory;

(iii) Defining a multi-dimensional characteristic space, whose dimensionality matches the number of object characteristics, and mapping object types to sub-spaces; and/or

(iv) Employing neural-network based algorithms, e.g., deep learning algorithms;

(b) The spatial region associated with the object within the local estimated signal frame may be directly processed using any method known in the art. For instance, neural-network based algorithms, such as deep learning algorithms, can be employed; and
(c) In order to reduce false alarm rates, one may exclude certain object types in predefined spatial regions (volumes), wherein these object types are not expected to be found.

### Detection Association and Tracking (Step 530)

In some embodiments of step 530, the associating detected objects in multiple local estimated signal frames comprises looking for detected objects in different local estimated signal frames, wherein the detected objects have sufficient similarity in one or more physical attributes (“association physical attributes”). The association physical attributes may include one or more of the following:

(a) Parameters relating to spatial location;
(b) Parameters relating to orientation;
(c) Parameters relating to dynamic properties, such as the motion pattern, the velocity vector and/or projections thereof, as well as the acceleration vector and/or projections thereof;
(d) Spatial dimensions, or projections thereof; and
(e) Parameters relating to object reflectivity.

In further embodiments of step 530, the generating track files comprises the application of any estimation method known in the art, e.g., a Kalman filter.

### Object Classification Based on Multiple Local Estimated Signal Frames (Step 540)

In certain embodiments of step 540, the classifying detected objects may employ any classification method known in the art. For instance, one or more of the following methods may be used for each object:

(a) One or more object characteristics may be computed for the object in a set of local estimated signal frames. The object characteristics may include, for example, parameters relating to object dimensions, parameters relating to the object's velocity and/or motion pattern as a function of time, and/or parameters relating to the object's reflectivity. The computed object characteristics may then be compared to reference models associated with certain object types using any technique known in the art, for instance:

(i) Applying one or more thresholds to each object characteristic, to obtain a set of binary values. Predefined logic criteria may then be applied to the set of binary values, e.g., the sum of the binary values should exceed a certain number;

(ii) Applying one or more thresholds to each object characteristic, to obtain a set of binary values, and then using the Dempster-Shafer theory;

(iii) Defining a multi-dimensional characteristic space, whose dimensionality matches the number of object characteristics, and mapping object types to sub-spaces; and/or

(iv) Employing neural-network based algorithms, e.g., deep learning algorithms;

(b) One or more object characteristics may be computed for the object, for each of multiple local estimated signal frames separately. The object characteristics may include, for example, parameters relating to object dimensions, parameters relating to the object's current velocity, and/or parameters relating to the object's reflectivity. The computed object characteristics may then be analyzed by any method known in the art, for instance, using hidden Markov models (HMM), and/or neural-network based algorithms such as deep learning algorithms;
(c) The spatial region associated with the object within multiple local estimated signal frames may be directly processed using any method known in the art. For instance, neural-network based algorithms, such as deep learning algorithms, can be employed; and
(d) In order to reduce false alarm rates, one may exclude certain object types in predefined spatial regions (volumes), wherein these object types are not expected to be found.

### Spatial Imaging Example

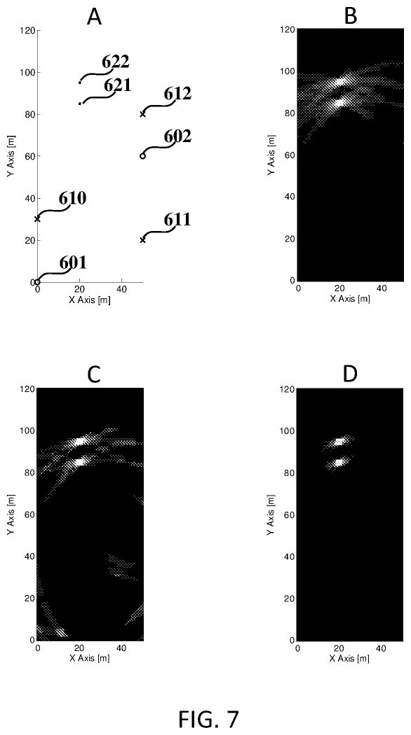

In an example system configuration, depicted in FIG. 7A, there are two transmitting subject network nodes, marked by 601 and 602, and three node signal receivers, marked by 610, 611, and 612. Each of the transmitting subject network nodes employs a bandwidth of 50 MHz. Each of the node signal receivers uses multiple (in this case, 20) concurrent receive beams, equidistantly covering 360°, wherein the azimuth beam width of each receive beam is 22°. The target volume is assumed to be two-dimensional, and include two point (or point-like) reflectors, 10 m apart. Based on a Matlab simulation, the bi-static local estimated signals for each of the transmitting subject network nodes and each of the node signal receivers are shown in FIG. 8. The resulting local estimated signal, without using the variability factor, is shown in FIG. 7B. The resulting local variability factor (based on the overall energy ratio) is shown in FIG. 7C. The resulting local estimated signal, using the variability factor (based on the overall energy ratio), is shown in FIG. 7D. As expected, we can see that in this example the local estimated signal has better PSF model (and therefore better spatial resolution) than any of the bi-static local estimated signals. We can also see that using the variability factor can further enhance the PSF model.

### Time/Phase Calibration

The spatial imaging processing may be affected by one or more of the following, which can potentially widen the PSF of the spatial imaging output and therefore reduce its spatial resolution:

(a) Inaccuracies in the spatial locations of the node signal receivers (30), used for processing;
(b) Inaccuracies in the spatial locations of the transmitting subject network nodes (11), used for processing; and
(c) Relative time and/or phase shifts in the clocks used by the node signal receivers (30).
The node signal receivers (30) and the transmitting subject network nodes (11) are typically stationary, and their spatial locations are well known. Conversely, time and/or phase shifts are expected even for node signal receivers (30) which include a GNSS receiver (35).

In some embodiments, time and/or phase shifts in the clocks used by the node signal receivers (30) can be estimated and corrected for using the following processing:

(a) Arbitrarily select the clock of one of the node signal receivers (30) as accurate;
(b) Estimate the relative time and/or phase shifts of the clocks of the remaining node signal receivers (30), based on the fact that when introducing accurate time and/or phase shift corrections to the clocks, the spatial imaging PSF is expected to be narrowest throughout most of the target volume. This can be done using one or more of the following:

(i) Estimating the relative time and/or phase shifts by minimizing one or more global parameters of the local estimated signal obtained using various possible time and/or phase shift corrections (“global minimization parameters”). The global minimization parameters may include one or more of the following: a statistic over the target volume of the local spatial auto-correlation width (along one or more spatial axes); and a statistic over the target volume of the local auto-correlation area/volume, wherein local spatial auto-correlation area/volume is defined as the result of multiplying the local auto-correlation widths along two or more spatial axes;

(ii) Estimating the relative time and/or phase shifts by minimizing one or more parameters of the local estimated signal obtained using various time and/or phase shift corrections, wherein said one or more parameters relate to specific spatial locations (“local minimization parameters”), wherein said specific spatial locations (“reference locations”) are expected to include essentially point-like reflectors. The reference locations may either be known in advance, or selected from the local estimated signal based on local spatial auto-correlation parameters. The local minimization parameters may include one or more of the following: a statistic over the reference locations of the local spatial auto-correlation width (along one or more spatial axes); and a statistic over the reference locations of the local auto-correlation area/volume.

### Examples For Applications

The systems and methods of the present invention may be used for a wide variety of applications. Many of these applications are relevant for smart cities. Some examples for applications:

(a) Systems for security, public safety, law enforcement, and/or rescue management. These systems may detect, localize, characterize, classify, and/or track objects within target volumes. These systems may also detect and/or classify carried objects, such as concealed weapons, explosives and/or drugs. The coverage volumes of these systems may match the type of subject networks used. For example, WPANs may be employed for personal security systems; WLANs for home security systems or for security systems for large buildings or facilities, such as shopping centers, airport terminals, oil rigs and the like; and cellular networks for securing large areas, e.g., city centers, agricultural areas, or borders;
(b) Systems for traffic analysis, parking management, and/or urban planning. These systems may detect and track people and/or vehicles over time. Various network types may be employed, including, for instance, WLANs and/or cellular networks;
(c) Obstacle detection for moving vehicles, e.g., trains, trucks, busses and cars. In some embodiments, additional transmitting subject network nodes (11) may be installed on the moving vehicles themselves, and/or on other platforms; and
(d) Terrain and/or volume mapping systems, e.g., for cartography. Such systems are typically designed to acquire information regarding immobile objects, whereas mobile elements are discarded.

One of the advantages of the systems and methods of the current invention is that the information regarding the terrain and/or the objects within the target volume is acquired using transmissions of wireless networks, which are very common nowadays. The fact that wireless networks are used:

(a) Contributes to the systems' cost-effectiveness, since already existing systems are utilized; and
(b) Minimizes radiation levels, since a significant portion of the transmissions are made for other purposes.

### Information Compounding and System Integration

In some embodiments, the systems of the present invention may be employed as bi-static radar arrays, where the transmitting subject network nodes (11) act as transmitting radar units, and the node signal receivers (30) act as receiving radar units. In such cases, the outputs of spatial imaging may be compounded with the outputs of bi-static radar array processing, to extract more information from the system. For instance, bi-static radar array processing may better detect fast moving objects, whereas spatial imaging processing may better detect stationary or slow moving objects.

In certain embodiments, the systems of the present invention may further include additional sensors, providing supplementary information to the mapping units (45). Additionally or alternatively, the outputs of the systems of the present invention may be compounded with the outputs of other sensors or systems, to provide richer and/or more accurate information.

For example, in security applications, the additional or other sensors may include one or more sensors traditionally employed in security and surveillance systems, such as motion sensors, photo-electric beams, shock detectors, glass break detectors, still and/or video cameras (optic and/or electro-optic), other electro-optic sensors, radars, lidar systems, and/or sonar systems.

In the above description, an embodiment is an example or implementation of the invention. The various appearances of “one embodiment”, “an embodiment”, “some embodiments”, “other embodiments”, “further embodiments”, or “certain embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment. Furthermore, it is to be understood that the invention can be carried out or practiced in various ways and that the invention can be implemented in embodiments other than the ones outlined in the description above.

Meanings of technical and scientific terms used herein are to be commonly understood as by one of ordinary skill in the art to which the invention belongs, unless otherwise defined.

1. A method for spatial imaging, providing a local estimated signal for a target volume, which is indicative of the local signal reflectivity within the target volume, said method comprising:
receiving node resultant signals using one or more node signal receivers, wherein node resultant signals comprise node signals transmitted by one or more nodes of wireless networks and received after traversing a medium, and wherein each of the one or more node signal receivers is configured to receive signals associated with one or more transmitting subject network nodes; and
for at least one of the one or more node signal receivers, for at least one of the associated one or more transmitting subject network nodes, generating a bi-static local estimated signal, being an initial version of the local estimated signal, using the following processing steps:
a. Applying matched filtering between the node resultant signal received by the current node signal receiver and the waveform of the current transmitting subject network node, and outputting a matched node resultant signal, provided as a function of time, wherein time is correlated to a bi-static distance with respect to the current node signal receiver and the current transmitting subject network node;
b. For one or more spatial locations within the target volume, computing (60), compute-the bi-static distance with respect to the current node signal receiver and the current transmitting subject network node, wherein the spatial location of each of the current node signal receiver and the current transmitting subject network node is known, measured, or estimated; and
c. For each of the one or more spatial locations within the target volume, determining the bi-static local estimated signal based on the value of the matched node resultant signal at the bi-static distance corresponding to the current spatial location.

2. A method according to claim 1, wherein spatial imaging further comprises compounding two or more bi-static local estimated signals, associated with two or more node signal receivers and/or two or more transmitting subject network nodes, to obtain the local estimated signal.

3. A method according to claim 2, wherein the compounding two more bi-static local estimated signals provides one or more of the following:
a. Enhanced signal to noise ratios (SNRs);
b. Reduced multi-path artifacts; and
c. Improved point-spread function (PSF).

4. A method according to claim 1, wherein spatial imaging is applied in one of the following ways:
a. once, using node resultant signals associated with a certain time swath; or
b. multiple times (in multiple instances), wherein each instance is associated with a different time swath, and wherein the output of each instance is a local estimated signal frame.

5. (canceled)

6. A method according to claim 4, wherein spatial imaging further comprises one or more of the following post-processing steps, applied to the local estimated signal and/or to the bi-static local estimated signal:
a. Applying integration over time, wherein the integration is performed separately for one or more spatial locations within the target volume;
b. Applying image enhancement algorithms;
c. Detecting objects within the target volume;
d. Classifying detected objects within the target volume, based on a single local estimated signal frame;
e. Associating detected objects in multiple local estimated signal frames and generating one or more track files, wherein the associated detected objects are assumed to correspond to a single physical object, and wherein each of the one or more track files is a record of the physical object's estimated location and attributes over time; and
f. Classifying detected objects within the target volume, based on multiple local estimated signal frames.

7. (canceled)

8. A method according to claim 1, wherein each of the waveforms of the transmitting subject network nodes is one or more of the following:
a. Fully known in advance, and used in its entirety for the matched filtering;
b. Partially known in advance, wherein only the part known in advance is used for the matched filtering;
c. Partially known in advance, wherein the unknown part or certain portions thereof are estimated based on the communication protocol used by the transmitting subject network node, and wherein both the part known in advance and the estimated part are used for the matched filtering; and
d. Not known in advance, and partially or fully estimated based on the communication protocol used by the transmitting subject network node, wherein the estimated part is used for the matched filtering.

9. A method according to claim 1, wherein one or more of the transmitting subject network nodes employ orthogonal frequency division multiple access (OFDMA), wherein each narrow-band transmission of OFDMA is a resource element (RE), and wherein the matched filtering associated with the one or more of the transmitting subject network nodes that employ OFDMA is applied using one or more of the following:
a. A single RE;
b. Multiple concurrent REs; and
c. Multiple REs which are not all concurrent, wherein each RE is associated with a different carrier frequency. cm 10. A method according to claim 1, wherein one or more transmitting subject network nodes use channel aggregation, and wherein the matched filtering associated with transmitting subject network nodes using channel aggregation comprises one or more of the following:
a. Treating the transmitting subject network node as two or more transmitting subject network nodes, each associated with a different continuous frequency band of the waveform;
b. Applying interpolation over the transmission frequency axis between the different continuous frequency bands of the waveform, so as to produce a single continuous frequency band, and then applying matched filtering; and
c. Applying the matched filtering without special regard to the use of channel aggregation

11. (canceled)

12. A method according to claim 1, wherein two or more transmitting subject network nodes are co-located nodes and use orthogonal frequency bands, and wherein the matched filtering associated with co-located nodes comprises one or more of the following:
a. Treating each of the co-located nodes as a separate transmitting subject network node;
b. Applying matched filtering together to the node resultant signals associated with the co-located nodes; and
c. Applying interpolation over the transmission frequency axis between the node resultant signals associated with the co-located nodes, so as to produce a single continuous frequency band, and then applying matched filtering.

13. (canceled)

14. A method according to claim 1, wherein the matched node resultant signal is computed for a set of time indices, corresponding to a set of range-gates, and wherein the value of the matched node resultant signal at the current bi-static distance corresponding to the current spatial location is estimated by one of the following:
a. Using the matched node resultant signal at a range-gate whose bi-static distance is closest to the current bi-static distance; and
b. Applying interpolation to the matched node resultant signal so as to obtain its value at the current bi-static distance.

15. A method according to claim 1, wherein for each of the one or more spatial locations within the target volume, the bi-static local estimated signal is set either to a value of the matched node resultant signal at the bi-static distance corresponding to the current spatial location; or to a bi-static function of the matched node resultant signal at the bi-static distance corresponding, to the current spatial location.

16. (canceled)

17. A method according to claim 15, wherein the bi-static function further depends on one or more of the following:
a. The current bi-static distance;
b. The distance between the current spatial location and the current transmitting subject network node;
c. The distance between the current spatial location and the current node signal receiver;
d. The spatial angle of the current spatial location with respect to the current transmitting subject network node;
e. The spatial angle of the current spatial location with respect to the current node signal receiver;
f. A system parameter of the current transmitting subject network node; and
g. A system parameter of the current node signal receiver.

18. A method according to claim 17, wherein the bi-static function includes one or more of the following:
a. A phase correction, subtracting a phase corresponding to the current bi-static distance;
b. A phase correction, subtracting a phase corresponding to the distance between the current spatial location and the current node signal receiver;
c. An energy compensation, countering the effect of path-loss between the current transmitting subject network node and the current spatial location;
d. An energy compensation, countering the effect of path-loss between the current spatial location and the current node signal receiver;
e. An energy compensation, countering the effect of the mean transmission power and/or maximal gain (on transmission) of the current transmitting subject network node;
f. An energy compensation, countering the effect of the sensitivity and/or maximal gain (on reception) of the current node signal receiver;
g. A multiplicative factor, limiting the effect of each node resultant signal on the bi-static local estimated signal to the region covered by the corresponding receive beam of the corresponding node signal receiver;
h. An energy correction, based on the beam pattern of the receive beam of the current node signal receiver at a spatial angle corresponding to the current spatial location; and
i. A multiplicative factor, reducing the effect of matched node resultant signals associated with relatively low bi-static distances.

19. A method according to claim 1, wherein at least one of the node signal receivers employs multiple concurrent receive beams, each associated with a different node resultant signal, wherein the bi-static local estimated signal is computed separately for one or more of the multiple concurrent receive beams, and wherein bi-static local estimated signals associated with two or more of the multiple concurrent receive beams of the same node signal receiver PA-are compounded using one or more of the following:
a. For each of the one or more spatial locations within the target volume, applying coherent integration (i.e., summation of the complex signals) between the bi-static local estimated signals associated with the two or more of the multiple concurrent receive beams. The coherent integration may assign the same weight to all of the multiple concurrent receive beams, or different weights to different ones of the multiple concurrent receive beams;
b. For each of the one or more spatial locations within the target volume, applying non-coherent integration (i.e., summation of the absolute values) between the bi-static local estimated signals associated with the two or more of the multiple concurrent receive beams. The non-coherent integration may assign the same weight to all of the multiple concurrent receive beams, or different weights to different ones of the multiple concurrent receive beams; and
c. For each of the one or more spatial locations within the target volume, averaging over the absolute values of the bi-static local estimated signals associated with the two or more of the multiple concurrent receive beams.

20. (canceled)

21. A method according to claim 2, wherein the compounding two or more bi-static local estimated signals comprises one or more of the following:
a. For one or more spatial locations within the target volume, applying coherent integration (i.e., summation of the complex signals) between the bi-static local estimated signals associated with the two or more node signal receivers and/or the two or more transmitting subject network nodes. The coherent integration may assign the same weight to all bi-static local estimated signals, or different weights to different bi-static local estimated signals;
b. For one or more spatial locations within the target volume, applying non-coherent integration (i.e., summation of the absolute values) between the bi-static local estimated signals associated with the two or more node signal receivers f3-g)-and/or the two or more transmitting subject network nodes. The non-coherent integration may assign the same weight to all bi-static local estimated signals, or different weights to different bi-static local estimated signals;
c. For one or more spatial locations within the target volume, averaging over the absolute values of the bi-static local estimated signals associated with the two or more node signal receivers and/or the two or more transmitting subject network nodes.

22. A method according to claim 2, wherein the compounding two or more bi-static local estimated signals employs one or more of the following:
a. a weight computed for each bi-static local estimated signal, wherein said weight is a function of the information quality level of the corresponding bi-static local estimated signal, and wherein the information quality level is derived from one or more of the following:
i. A certain statistic of the estimated signal to noise ratio (SNR) for the corresponding matched node resultant signal. Higher SNRs are indicative of better information quality; and
ii. A certain statistic of the auto-correlation width of the corresponding matched node resultant signal. Lower auto-correlation widths are indicative of better information quality; and
b. A variability factor computed for one or more spatial locations within the target volume, wherein the variability factor is a local measure of the similarity between the values of the bi-static local estimated signals.

23. (canceled)

24. A method according to claim 22, wherein the variability factor relates to one or more of the following components of the values of the bi-static local estimated signals:
a. Magnitude;
b. Phase;
c. Real component; and
d. Imaginary component.

25. A method according to claim 22, wherein the variability factor for a present spatial location within the target volume is one or more of the following:
a. A function of the overall energy ratio, wherein the overall energy ratio for the present spatial location is computed as follows:
i. Determining the overall bi-static array for the present spatial location, wherein the overall bi-static array comprises absolute values of the two or more bi-static local estimated signals (being compounded) for the present spatial location; and
ii. Setting the overall energy ratio to the ratio between the DC energy and the total energy of the overall bi-static array; and
b. A function of the average energy ratio, wherein the average energy ratio for the present spatial location is computed as follows:
i) For each of the transmitting subject network nodes
1) Out of the two or more bi-static local estimated signals (being compounded), selecting the bi-static local estimated signals associated with the current transmitting subject network node;
2) Determining the partial bi-static array for the present spatial location, wherein the partial bi-static array comprises the values of the selected bi-static local estimated signals; and
3) Computing the partial energy ratio, wherein the partial energy ratio comprises a ratio between the DC energy and the total energy of the partial bi-static array
ii) The average energy ratio is set to the average over all partial energy ratios.

26. (canceled)

27. A method according to claim 2, wherein the compounding two or more bi-static local estimated signals further comprises the following iterative post-processing:
a) Detecting the spatial location or spatial locations within the target volume associated with signal peak regions, each being a high magnitude region within the local estimated signal;
b) Treating the local estimated signal within the signal peak region as a description of one or more simulated peak reflectors within the target volume, whose spatial locations match the signal peak region and whose reflectivity levels equal the corresponding values of the local estimated signal; and estimating the node resultant signals that would have been obtained by the one or more node signal receivers given the simulated peak reflectors using the bi-static radar equation, to obtain the simulated peak node resultant signals;
c) Applying spatial imaging (without post-processing) to the simulated peak node resultant signals, to obtain the simulated peak local estimated signal;
d) For each of the spatial locations within the signal peak region, multiplying the local estimated signal by a factor of 2;
e) For each local estimated signal location, being a spatial location within the target volume for which the local estimated signal is computed, subtract from the local estimated signal the simulated peak local estimated signal; and
f) As long as certain stopping criteria have not been met, detect the next signal peak region, associated with the next highest magnitude region within the local estimated signal, and return to (b).

28. A method according to claim 2, wherein the compounding two or more bi-static local estimated signals further comprises the following iterative post-processing:
a. Computing simulated node resultant signals, being the node resultant signals that would have been obtained given a set of reflectors described by the local estimated signal, by performing the following for each node signal receiver and for each transmitting subject network node:
Treating the local estimated signal as a description of a set of point reflectors within the target volume, whose spatial locations match the local estimated signal locations (the spatial locations within the target volume for which the local estimated signal is computed), and whose reflectivity levels equal the corresponding values of the local estimated signal; and evaluating the reflector signal, wherein the reflector signal comprises the resulting signal received by the current node signal receiver. The magnitude of the reflector signal is derived from the bi-static radar equation, and the phase of the reflector signal takes into account bi-static wave propagation; and
For each receive beam, for each range-gate, determining the set of local estimated signal locations falling within a range swath associated with the current range-gate, and applying coherent integration over the corresponding reflector signals, to obtain the simulated node resultant signal;
b. For each node resultant signal, computing the difference between the corresponding simulated node resultant signal and the corresponding measured node resultant signal, to obtain the =node resultant signal difference;
c. Applying spatial imaging (without post-processing) to the node resultant signal difference, to obtain the simulated difference local estimated signal;
d. For each of the local estimated signal locations, subtracting from the local estimated signal the value of the simulated difference local estimated signal; and
e. As long as certain stopping criteria have not been met, returning to (a).

29. A method according to claim 6, wherein the integration over time employs different integration times for different object types, and wherein spatial imaging is performed iteratively:
a. Setting the current integration time to the shortest integration time possible;
b. Integrating the local estimated signal over time, using the current integration time. The integration may employ sliding-window processing;
c. Applying further processing to the output of step (b), to detect objects of the types corresponding to the current integration time;
d. Subtracting from the local estimated signal the contribution of the detected objects; and
e. If the current integration time is not the longest integration time possible, setting the current integration time to the next shortest integration time and return to step (b).

30. (canceled)

31. A method according to claim 6, wherein the detecting objects within the target volume is based on one or more of the following:
a. Applying a local and/or a global threshold to the magnitude of the local estimated signal;
b. Automatic recognition of various object types, using any automatic target recognition (ATR) method known in the art; and
c. Motion detection, by arranging the local estimated signal data in accordance with its acquisition time and applying any change detection algorithm known in the art.

32. A method according to claim 6, wherein the associating detected objects in multiple local estimated signal frames comprises looking for detected objects in different local estimated signal frames, wherein the detected objects have sufficient similarity in one or more association physical attributes, and wherein the association physical attributes include one or more of the following:
a, Parameters relating to spatial location;
b. Parameters relating to orientation;
c. Parameters relating to dynamic properties;
d. Spatial dimensions, or projections thereof; and
e. Parameters relating to object reflectivity.

33. (canceled)

34. (canceled)

35. A system for spatial imaging, information regarding terrain and/or objects within a target volume, said system comprising: one or more node signal receivers, wherein each node signal receiver is configured to receive node resultant signals associated with one or more transmitting subject network nodes, wherein the node resultant signals comprise node signals transmitted by one or more transmitting subject network nodes and received after traversing a medium; and one or more mapping units, configured to process the outputs of the node signal receivers; wherein the node signal receivers and/or the mapping units provide a local estimated signal, being an estimate of local signal reflectivity within the target volume.

36. A system according to claim 35, wherein the providing a local estimated signal comprises:
for at least one of the one or more node signal receivers, for at least one of the associated one or more transmitting subject network nodes, generating a bi-static local estimated signal, being an initial version of the local estimated signal, using the following processing steps:
a. Applying matched filtering between the node resultant signal received by the current node signal receiver and the waveform of the current transmitting subject network node, and outputting a matched node resultant signal, provided as a function of time, wherein time is correlated to a bi-static distance with respect to the current node signal receiver and the current transmitting subject network node;
b. For one or more spatial locations within the target volume, computing the bi-static distance with respect to the current node signal receiver and the current transmitting subject network node, wherein the spatial location of each of the current node signal receiver and the current transmitting subject network node is known, measured, or estimated; and
c. For each of the one or more spatial locations within the target volume, determining the bi-static local estimated signal based on the value of the matched node resultant signal at the bi-static distance corresponding to the current spatial location.

37. A system according to claim 35, further comprising one or more user interface units, capable of controlling the system and/or displaying its outputs.

38. A system according to claim 35, wherein one or more of the following applies to each of the one or more node signal receivers:
a. The node signal receiver is passive;
b. The node signal receiver is active; and
c. The node signal receiver is integrated with a node of a wireless network.

39. (canceled)

40. (canceled)

41. (canceled)

42. A system according to claim 35, wherein each of the one or more node signal receivers comprises: an antenna module, used for receiving signals, and optionally for transmitting signals; an RF module, applying analog-to-digital (A/D) conversion to the signal received from the antenna module, and optionally including a transmitter feeding the antenna module;
a digital module, processing samples generated by the RF module, and optionally determining parameters for the RF module and/or the antenna module; and a power supply, optionally including a battery.

43. A system according to claim 42, wherein at least one of the one or more node signal receivers further comprises one or more of the following:
a. A global navigation satellite system (GNSS) receiver, providing accurate time and/or location information to the digital module, and
b. A wired or wireless communication module, which can be used for data transfer between the digital and the mapping units.

44. A system according to claim 35, wherein each of the one or more node signal receivers employs one or more of the following:
a. A single receive beam, pointing at a constant direction;
b. A single receive beam, whose direction changes over time, by mechanical and/or electronic steering; and
c. Multiple concurrent receive beams, each pointing at a different spatial angle, and configured as a staring array.

45. A system according to claim 35, wherein each mapping unit may either be a central mapping unit or a local mapping unit, and wherein one or more of the following applies:
a. The outputs of all node signal receivers are processed by one or more central mapping units;
b. Local mapping units are assigned to groups of one or more node signal receivers; and
c. Local mapping units are assigned to groups of one or more node signal receivers, and one or more central mapping units aggregate and further process the outputs of the local mapping units.

46. system according to claim 35, further comprising additional sensors, wherein each of the additional sensors may be one or more of the following:
a. Providing supplementary information to the mapping units; and
b. Providing information compounded with the outputs of mapping units;
and wherein one or more of the additional sensors is one of the following:
a. A motion sensor;
b. A photo-electric beam:
c. A shock detector;
d. A glass break detector;
e. A still camera, which may be optic and/or electro-optic;
f. A video camera, which may be optic and/or electro-optic;
g. An electro-optic sensor;
h. A radar;
i. A lidar system; and
j. A sonar system.

47. (canceled)

48. A system according to claim 35, used for one or more of the following applications:
a. Smart cities;
b. Security;
c. Public safety;
d. Law enforcement;
e. Rescue management;
f. Traffic analysis;
g. Parking management;
h. Urban planning;
i. Obstacle detection for moving vehicles; and
j. Terrain and/or volume mapping.
